(19) United States
(12) Patent Application Publication
(10) Pub. No.: US 2011/0225077 A1
(43) Pub. Date: Sep. 15, 2011

(54) Activity Ranking

(75) Inventor: Daniel Levitt, Chester (GB)

(73) Assignee: Bank of America Corporation, Charlotte, NC (US)

(21) Appl. No.: 12/722,589

(22) Filed: Mar. 12, 2010

(51) Int. Cl. G06Q 40/00

(52) U.S. Cl. 705/35

(57) ABSTRACT

A system and method of ranking activities and/or services to offer to a customer is provided. In some examples, one or more products, activities or services of a financial institution may be ranked for a customer based on customer information. One or more of the ranked products, activities and services may be offered to the customer. The customer's acceptance or refusal of the offered activity may be stored and used in future rankings.

### BACKGROUND

Today's banking industry is in a state of flux. As customers are being more thrifty and cautious with their money, financial institutions must continue to market new services and products to customers without alienating them or providing services and products that may not interest a customer. For instance, offering randomly selected services to customers on a repeated basis may cause the customer to refuse all offered services and products without considering the service or product. Further, customers desire financial products and services that will benefit them and will get them the most for their money. Often customers may feel overwhelmed by the number of products and services available to them. Accordingly, a system and method wherein a financial institution may focus or tailor products and services offered to the customer to that specific customer would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a system and method of ranking activities and/or services to offer to a customer of a financial institution are provided. In some examples, the system and method may include receiving, at an activity ranking system of a financial institution, data related to customer information for a customer of the financial institution from a data source. One or more activities, products, services, etc. may be ranked, at the activity ranking system, based on the received customer information. In some arrangements, at least one of the ranked activities, products, services, etc. may be offered to the customer. In some examples, the customer information may be received from one or more data sources that may be within the financial institution or external to the financial institution.

In other aspects, the system and method may include receiving ranked proposed activities for a customer, wherein the ranked proposed activities are ranked using customer information at an activity ranking system associated with a financial institution. In addition, the system and method may include receiving, at the financial institution, a first request for customer service from the customer and based on the received ranked proposed activities, offering at least one of the ranked proposed activities to the customer upon receiving the request for customer service from the customer. In some examples, the system and method may further include, upon the customer declining the offered at least one of the ranked proposed activities, generating revised rankings of the proposed activities at the activity ranking system based on the decline. The system and method may further include receiving a second request for customer service from the customer at the financial institution and offering the customer at least one of the generated revised ranked proposed activities.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for ranking activities and services according to one or more aspects described herein.

FIG. 3 illustrates one example method of ranking activities and/or services according to one or more aspects described herein.

FIG. 4 illustrates one example user interface for providing ranked activities and/or services to a customer according to one or more aspects described herein.

FIG. 5 illustrates another example method of ranking services and/or activities according to one or more aspects described herein.

FIG. 6 illustrates yet another example user interface for providing ranked activities and/or services to a customer according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

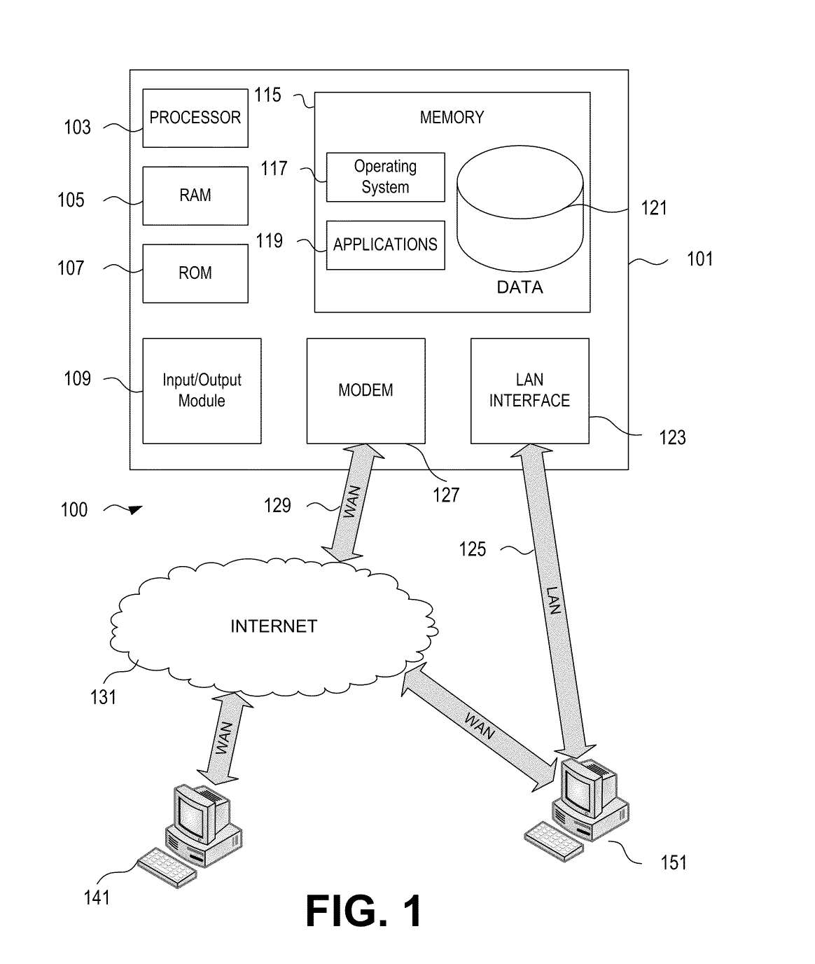

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in financial institutions to provide various customer services. For instance, various computing systems may be used to track and maintain customer information. Additionally or alternatively, online banking systems and customer service call centers may include various computing systems. At least some aspects of this disclosure relate to determining, based on various customer data (e.g., history of transactions, services being used, accounts being used, etc.) one or more activities or services that may be of interest to the customer. For instance, various activities or services may be ranked according to how likely the customer may be to desire the services, expected customer need, etc. These rankings aid in providing focused marketing to customers because activities and services being offered to the customer may be tailored to that customer based on the received, stored, collected, etc. customer information. Thus, the customer is more likely to be offered (such as via a customer service call center operator, online banking webpage, and the like) products of interest to them and the financial institution offering the products may be more likely to have the customer accept the product.

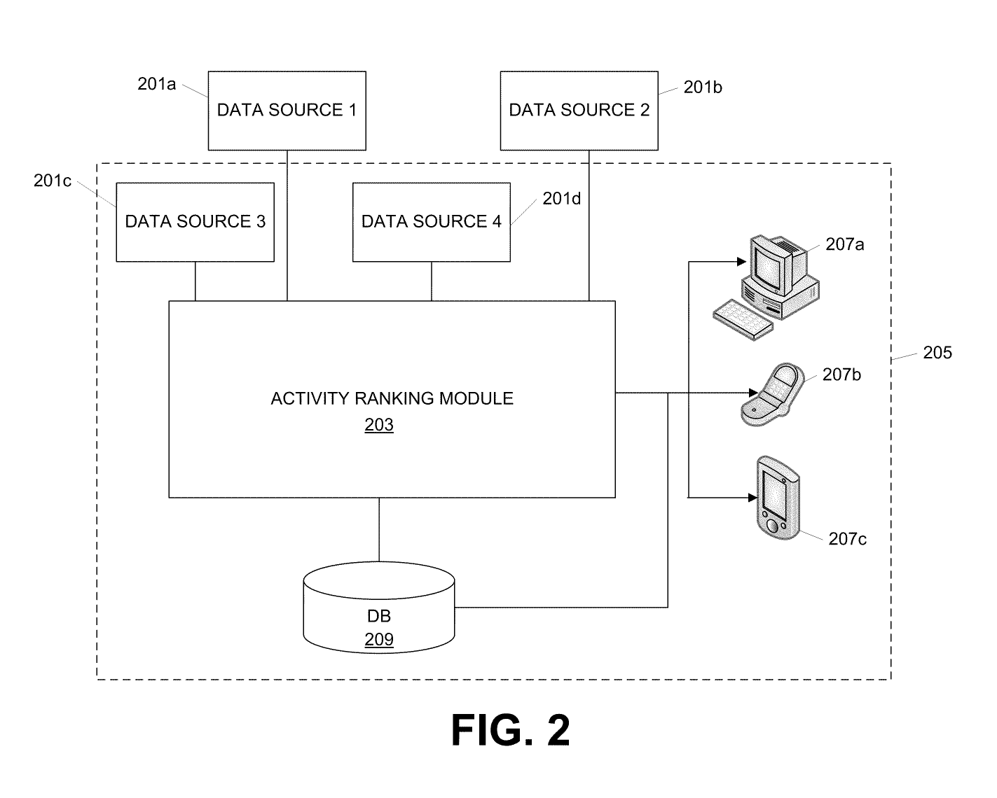

FIG. 2 illustrates one example system in which activities and services may be ranked and provided as options to a customer, such as a customer associated with a financial institution providing the activities and services. The system may include a plurality of data sources 201. These data sources 201 may include a variety of databases and other storage media that may be sources within the financial institution 205, such as data source 3 201c and data source 4 201d. Data sources 201c, 201d within the financial institution 205 may store customer banking records such as transactions, types of accounts, etc., personal customer information such as address, email address, other contact information, etc., customer preferences, and the like. Additionally or alternatively, data sources 201 may include data sources external to the financial institution 205, such as data source 1 201a and data source 2 201b. These external data sources 201a, 201b may be from sources not associated with the financial institution 205, such as vendors, business alliance partners, and the like. Data sources 201a, 201b may include and/or provide information regarding customer preferences, additional personal information, other accounts held by the customer (for instance, at other financial institutions, credit cards, etc.), marketing segment information, and the like.

Data sources 201 may transmit customer data to an activity ranking module 203. The activity ranking module 203 may receive customer information and, in response to the received customer information, determine various activities or services that may be of interest to the customer. Such activities or services may include new accounts available to open, promotions, collection or updating of personal information, such as an email address or marketing preferences, highlighting or identifying unused facilities or services that may be beneficial to the customer, such as faster service available online, account usage opportunities such as balance transfer opportunities, cross-sell opportunities such as related insurance or any other product or service the financial institution provides. The determined activities may then be ranked to determine which service or activity may be most appealing to a customer or may benefit a customer most, etc. These ranked activities may, in some arrangements, be stored, such as in database 209. In some examples, the ranked activities may be stored in look up tables that may be accessed by an online banking system, customer service call center associate, etc.

The ranked activities may be transmitted to one or more of output devices 207, which may include a computer 207a, mobile device 207b, personal digital assistant 207c, and the like. In some examples, the output device may be a computer at a customer service call center. For instance, when a customer calls into the customer service call center requesting service, the call center associate computer may receive the ranked activities and may offer one or more of the ranked services or activities to the customer. In some examples, the call center associate may receive a script when the customer calls in and the script may include an offer of one or more of the ranked services. If the user accepts or declines the offer, this information is stored in the customer data, such as data source 201, and may be used in later activity and/or service rankings for that customer.

Additionally or alternatively, the output device may be a customer computer (not shown), such a customer computer providing an online banking webpage of the financial institution 205 being accessed by the customer. The customer may, via the online banking system, be prompted to accept or reject an offer of one or more of the ranked activities or services. If the customer accepts or declines the offer, this information may be stored in the customer data, such as data sources 201, and may be used in later activity and/or service rankings.

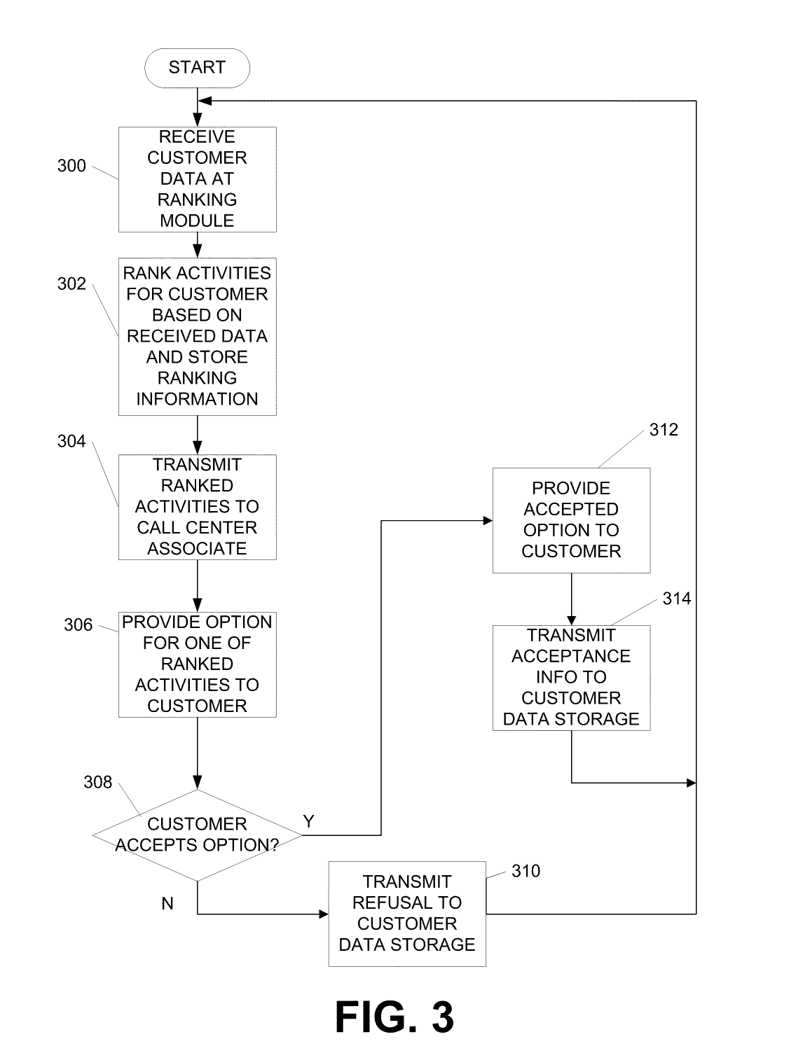

FIG. 3 illustrates one example method of ranking activities and services based on received customer information and providing an offer of the ranked activities or services to the customer. In step 300, customer data is received at the activity ranking module. As discussed above, the customer information may include customer account information, transaction history, personal information, and the like. The customer data may be received from one or more data sources that may be within the financial institution or external to the financial institution. In step 302, available activities and services that may be useful or beneficial to the customer are ranked based on the received customer data and the rankings may be stored. In some examples, the available activities and services may be only those activities and services that the customer has not already subscribed to or does not already participate in.

The ranking may be achieved or performed in a variety of ways. For instance, in some examples, modeling (e.g., using historical data from past success and failures (such as products or services accepted or declined) to solicit each activity) the Likelihood to Respond and the Predicted Future Value of each activity for each customer, and ranking the activities using both of these models in combination. Additionally or alternatively, including the cost per solicitation attempt (which will often vary according to the channel of contact), the cost of subsequent fulfillment required, etc. and any other factors that would contribute to the real costs and revenues of the activity may aid in improving accuracy and efficiency of the ranking. In still other examples, modifying the ranking by applying varying levels of suppression in line with feedback from the customer from previous attempts to solicit each activity may further improve the quality of the rankings.

Additional improved accuracy of the rankings may be provided by optimizing all the activities possible across all the customers; using commercially available optimizing software fed with all of the above information and the constraints of the financial institution (such as channel volume capacity, conversion rates by channel, contractual commitments to undertake particular amounts of specific activities, etc.). In some examples, an iterative process may be used to determine rankings to be presented or offered to the customer. Because the volume of information to be processed may be high and the interdependency between customers modeled may, in some examples, be a factor in the rankings, the optimization may be run periodically (typically daily, weekly, monthly, etc.) or aperiodically to update the stored rankings In the interim temporary suppressions may be applied in response to customers declining activities promoted, to prevent those same activities being promoted at a later contact before the full optimization process has been run again.

In step 304, the ranked activities and services are transmitted to a customer call center associate computer. For instance, if the customer calls into the customer service center, the ranked activities and/or services may be automatically transmitted to the call center associate's computer or workstation. Additionally or alternatively, the ranked activities may be transmitted to a customer service call center associate for the associate to contact the customer regarding subscribing to or accepting one or more of the ranked activities. In step 306, one or more of the ranked activities or services is offered to the customer, such as during a customer service call or during a marketing call in which the call center associate contacts the customer to offer the activities or services. In some examples, only the top ranked activity or service may be offered to the customer. The top ranked activity or service may be the activity or service determined to most likely appeal to or benefit the customer.

A determination is made as to whether the customer accepts or declines the offered one or more ranked activities and/or services in step 308. If the customer declines the offered one or more activities or services, that refusal may be transmitted to the customer data storage in step 310 in order to be used to determine future rankings of activities and services. For instance, if a determination is made that a balance transfer is the activity that may most appeal to a customer and is ranked highly but the customer recently refused the offer of the balance transfer, when activities are ranked for the same customer again the balance transfer may be ranked lower based on this refusal.

If, however, the customer accepts the offered activity or service, then the accepted option may be provided to the customer in step 312 and this acceptance and any associated information may be transmitted to customer data storage for use in future rankings. In some examples, acceptance by the customer may automatically initiate the activity or service for the customer.

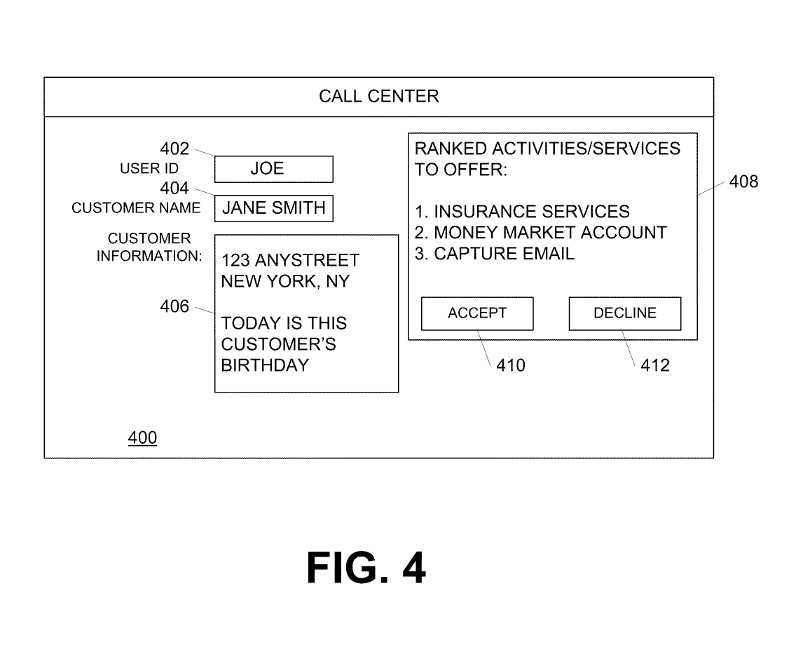

FIG. 4 illustrates one example user interface 400 that may be used to present ranked activities and/or services to a customer service call center associate. The interface 400 may include the name or other user identifier of the call center associate in field 402. The interface 400 may further include the customer's name in field 404 and any additional customer information in field 406. Additional customer information may include the customer's address, account history, etc. as well as personal information that may be used in the call.

User interface 400 may further include a ranked activities and services field 408. This field may include one or more ranked activities or services received from the activity ranking module. Accordingly, the call center associate may offer one or more of the ranked services to the customer. In some examples, the call center associate may receive scripts for the proposed ranked activities and the call on his or her workstation. These scripts may include an offer of the one or more ranked activities or services listed in field 408 for that customer, may be customized to suit marketing segments associated with the customer and/or may be personalized with data relating to the individual customer and their existing accounts and products with the financial institution. If the customer accepts the offered activity or service, the call center associate may select accept option 410 and may be prompted to input additional information and/or facilitate signing the customer up for or providing the service or activity. In some arrangements, the customer may choose to accept more than one activity or service if more than one is offered. This acceptance, and any additional information, may be transmitted to customer data storage for use in future rankings. If the offered activity or service is declined by the customer, the call center associate may select decline option 412 and this refusal may be transmitted to customer data storage for use in future rankings.

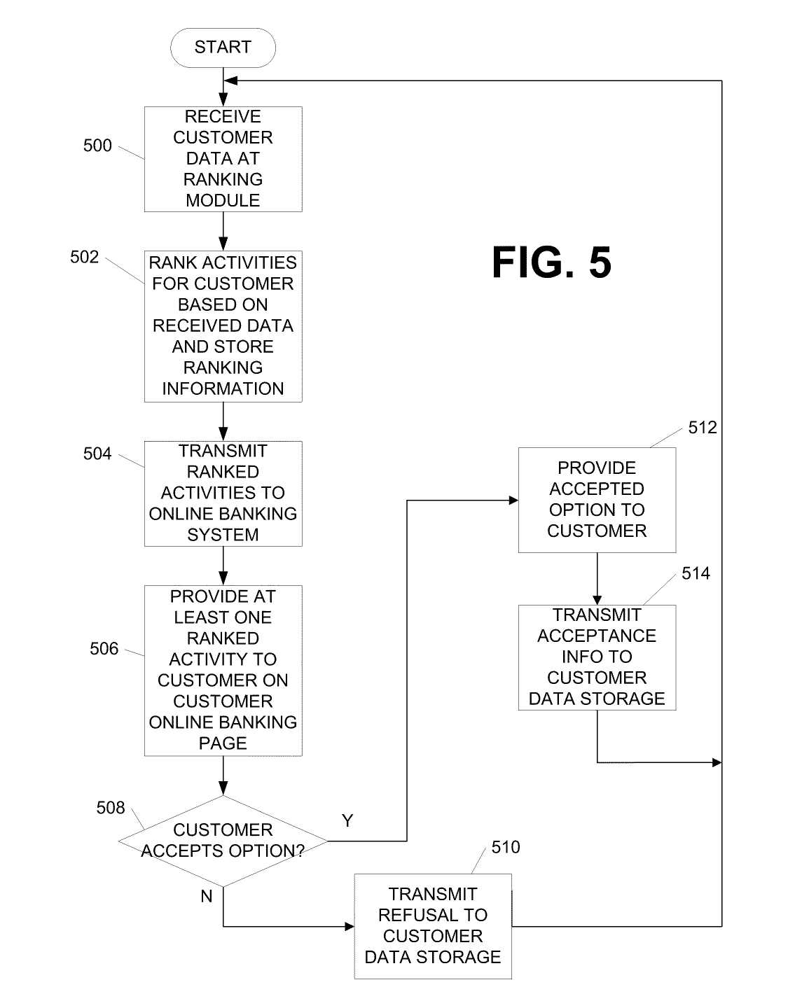

FIG. 5 illustrates another example method of ranking activities and services based on received customer information and providing an offer of the ranked activities or services to the customer. In step 500, customer data is received at the activity ranking module. Similar to the arrangement described above, the customer data may be received from one or more data sources that may be within the financial institution or external to the financial institution. In step 502, available services and/or activities for the customer are ranked and the ranking information may be stored. In step 504, the ranked activities and/or services are transmitted to an online banking system of the financial institution. For instance, the ranked activities and/or services may be provided to a customer via an online banking webpage being displayed on the customer's computer or workstation which may, in some examples, be outside the financial institution (e.g., unrelated to the financial institution). In some examples, the ranked activities and/or services may be transmitted automatically upon completion of the ranking or, alternatively, the ranked activities and/or services may be transmitted to the online banking system upon detecting a login of the customer. In step 506 at least one ranked activity and/or service is offered to the customer via the online banking system. In step 508, a determination is made as to whether the customer accepts or declines the offered activity or service. If the customer declines of the offered activity or service, that refusal may be transmitted to customer data store in step 510 for use in future rankings. Alternatively, if the customer accepts the offered activity or service, the customer is then provided with the accepted activity or service in step 512 and that acceptance, and any associated information, may be transmitted to customer data storage in step 514 for use in future rankings.

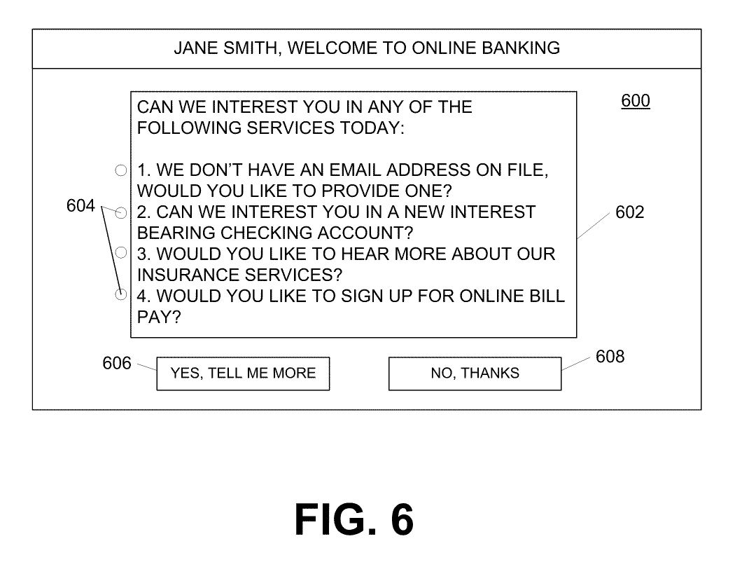

FIG. 6 illustrates one example may be used to present and/or offer ranked activities and/or services to a customer, such as via an online banking webpage. The interface 600 may include a ranked activity and/or services filed 602 which may list one or more ranked activities and/or services received, such as from the activity ranking module. In some examples, one or more activities may be presented as banner advertisements alongside a webpage and the activities shown, though driven by the ranking, may be filtered to be appropriate to the activity the customer is undertaking on that webpage or the main subject of it. In some examples, each activity and/or service may have a radio button 604 associated with it. The customer may, in some arrangements, select the radio button 604 associated with the desired activity or service. Alternatively or additionally, multiple options may be selected at the same time (e.g., using check boxes rather than a radio option). Once one or more activities or services are selected by the customer, the customer may select an accept option, such as yes, tell me more option 606. Selection of option 606 may prompt the user to provide additional information and or may request user input from the customer. Acceptance of the offered activity or service, as well as any associated information, may be transmitted to customer data storage for use in future rankings. Alternatively, the customer may decline the offered activity and/or service by selecting a decline option, such as no, thanks option 608. Refusal of the offered activity or service may be transmitted to customer data storage for use in future rankings.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
receiving, by an activity ranking system of a financial institution, data related to customer information for a customer of the financial institution from a data source;
ranking proposed activities at the activity ranking system based on the received customer information;
providing at least one of the ranked proposed activities to the customer of the financial institution.

2. The method of claim 1, wherein the data source is a data source within the financial institution.

3. The method of claim 1, wherein the data source is a data source external to the financial institution.

4. The method of claim 1, wherein the data source includes a plurality of data sources.

5. The method of claim 4, wherein the plurality of data sources includes at least one data source external to the financial institution.

6. The method of claim 1, wherein the ranked proposed activities are provided to the customer via an online banking system.

7. The method of claim 1, wherein the ranked proposed activities are provided to the customer via a customer service call center associate.

8. The method of claim 1, wherein the ranked proposed activities include at least one of services and products.

9. The method of claim 8, wherein the services include at least one of capturing preferred method of contact, capturing contact details, and updating personal information.

10. The method of claim 8, wherein the products include at least one of insurance products, credit card products, and financial account products.

11. A method, comprising:
receiving ranked proposed activities for a customer, wherein the ranked proposed activities are ranked using customer information at an activity ranking system associated with a financial institution;
receiving, at the financial institution, a first request for customer service from the customer; and
based on the received ranked proposed activities, offering at least one of the ranked proposed activities to the customer upon receiving the request for customer service from the customer.

12. The method of claim 11, further including:
responsive to the customer declining the offered at least one of the ranked proposed activities, generating revised rankings of the proposed activities at the activity ranking system based on the decline.

13. The method of claim 12, further including:
receiving a second request for customer service from the customer at the financial institution; and
offering the customer at least one of the generated revised ranked proposed activities.

14. The method of claim 11, further including:
responsive to the customer accepting the offered at least one of the ranked proposed activities, providing the accepted activity to the customer and generating revised rankings of the proposed activities at the activity ranking system based on the acceptance.

15. The method of claim 11, wherein the ranked proposed activities include at least one of insurance products, financial account products, and credit card products.

16. One or more computer readable media storing computer readable instructions that, when executed, cause an apparatus to:
receive, at an activity ranking system of a financial institution, data related to customer information for a customer of the financial institution from a data source;
rank proposed activities at the activity ranking system based on the received customer information;
provide at least one of the ranked proposed activities to the customer of the financial institution.

17. The one or more computer readable media of claim 16, wherein the data source is a data source within the financial institution.

18. The one or more computer readable media of claim 16, wherein the data source is a data source external to the financial institution.

19. The one or more computer readable media of claim 16, wherein the data source includes a plurality of data sources.

20. The one or more computer readable media of claim 16, wherein the computer readable instructions, when executed, further cause the apparatus to:
receive a refusal of the provided at least one of the ranked proposed activities; and
responsive to receiving the refusal, generate revised rankings of the proposed activities based on the refusal.

21. The one or more computer readable media of claim 16, wherein the at least one of the ranked activities is provided to the customer via an online banking system.

22. The one or more computer readable media of claim 16, wherein the at least one of the ranked proposed activities is provided to the customer via a customer service call center associate.

23. An apparatus comprising:
a processor; and
memory operatively coupled to the processor and storing computer readable instructions that, when executed, cause the apparatus to:
receive, at an activity ranking system of a financial institution, data related to customer information for a customer of the financial institution from a data source;
rank proposed activities at the activity ranking system based on the received customer information;
provide at least one of the ranked proposed activities to the customer of the financial institution.

24. The apparatus of claim 23, wherein the data source is a data source within the financial institution.

25. The apparatus of claim 23, wherein the data source is a data source external to the financial institution.

26. The apparatus of claim 23, wherein the data source includes a plurality of data sources.
